(19) United States
(12) Patent Application Publication
(10) Pub. No.: US 2016/0363281 A1
(43) Pub. Date: Dec. 15, 2016

(54) DAYTIME RUNNING LAMP OF A VEHICLE

(71) Applicant: Chen-Wei HSU, Tainan (TW)

(72) Inventor: Chen-Wei HSU, Tainan (TW)

(21) Appl. No.: 14/738,940

(22) Filed: Jun. 15, 2015

(51) Int. Cl. F21S 8/10; B60Q 1/04

(52) U.S. Cl. CPC F21S 48/1109; F21S 48/1154; F21S 48/1216; F21S 48/1266; F21S 48/1275; F21S 48/142; B60Q 1/04; B60Q 2400/30

(57) ABSTRACT

A daytime runner lamp of a vehicle consisted of a lamp base having chamber and securing grooves and fins on its outer walls, a circuit board defined inside of the chamber, a lens placed in front of the circle board inside of the chamber having a plan surface at rear and various wavy refracting faces corresponding to LED lights on circle board in front surface, a lampshade placed in front of the lamp base and a fixing member placed behind the lamp base having securing members corresponding the securing grooves of the lamp base. The daytime runner lamp could be installed either in front or at tail of a vehicle so that the light would be on while driving at daytime.

### BACKGROUND OF THE INVENTION

1. Fields of the Invention

The present invention relates to a daytime running lamp of a vehicle, and more particularly, to a daytime running lamp able to be installed either in front or at rear of a vehicle in order to be lighted and alarmed while driving at daytime.

2. Descriptions of Related Art

Car crushes are continually happened by number of vehicles increasing, so, vehicle daytime running lamp (as known as DRL) installation is mandatory in EU. The DRL is helpful to prevent cars from car crush by making vehicle conspicuous which means the DRL would be automatically on while the vehicle engine stating in order to be visualized at daytime. In other words, the car with DRL could be easily seen by other car drivers, pedestrians or animals on time so that a car crush could be easier to be avoid because of bad weather bad visual. Commonly, a DRL is built inside of a headlight which is also comprised of a low beam light, high beam light, direction light and DRL, however, the headlight with DRL is only installed in a new car. In case of installing a DRL in old car, a new headlight with DRL ought to be replaced, but it costs fortune and takes time. Normally, the light from DRL is used a shade to reflect the Light Emitting Diode (as known as LED) light firstly and then to project the light out. As result, the projecting light won't be well distributed which means the center of the light projection area would be brighter but other part of the light projection area is brighten less. Moreover, the projection light could be scattered or glared so as to effect other drivers' vision.

The present invention intends to provide a daytime runner lamp of a vehicle that effectively improves the shortcomings mentioned above.

### SUMMARY OF THE INVENTION

The present invention relates to a daytime runner lamp of a vehicle consisted of a lamp base, a circuit board, a lens, a lampshade and a fixing member. A chamber is defined inside of the lamp base. Plural securing grooves are defined respectively on top and bottom outer wall of the lamp base. Several dissipation fins are defined on the outer wall of the lamp base. A hole is provided with a wire stopper at rear wall of the lamp base. At least two threaded holes are defined inside of the chamber of the lamp base, and a positioning groove is defined along with the front edge of the lamp base. The circle board is inserted inside of the chamber of the lamp base. Several LED lights are aligned on the circle board. At least one positioning hole is defined respectively at the two ends of the circle board. Number of wires provided with the circle board are able to be inserted through the wire stopper. The lens is inserted inside of the chamber of the lamp base and located in front of the circle board. The rear surface of the lens is plan and the front surface of the lens is designed in various wavy refracting faces which are respectively corresponding to the LED lights on circle board. At the two ends of the lens are defined respectively a convex which has a thru hole able to be inserted by a screw used to be secured into the threaded hole of the lamp base. At least two positioning projectors corresponding respectively to the positioning holes of the circle board are defined on rear surface of the lens. The lampshade is transparency and defined in front of the lamp base. A projecting edge corresponding to the positioning groove of the lamp base is defined along with the edge at rear side of lampshade. The fixing member which has plural securing members corresponding respectively to the securing grooves on outer wall of the lamp base defined respectively on top and bottom side of the fixing member, various thru holes and a penetrating hole is placed behind the lamp base.

Preferably, the wire stopper has an annular groove able to be engaged into the hole of the lamp base on the outer wall and at least one hole able to collect the wires of the circle board.

Preferably, two shades defined respectively at the two ends of the lampshade are able to shield the connection portion of the lens secured inside of lamp base so as to the appearance of the daytime runner lamp could be attractively.

The advantage of the present invention is that it doesn't have to be assembled with vehicle headlight which means it can solo be assembled in a vehicle in a simple and fast way but also the light projecting from the present invention could be well distributed without glare.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the daytime runner lamp of a vehicle of the present invention;

FIG. 2 is another exploded view of the daytime runner lamp of a vehicle of the present invention;

FIG. 3 is an exploded view of the lamp and the fixing member of the daytime runner lamp of a vehicle of the present invention;

FIG. 4 is a perspective view of the daytime runner lamp of a vehicle of the present invention, and

FIG. 5 is a cross section view of the daytime runner lamp of a vehicle of the present invention.

### DETAILED DESCRIPTION OF THE PREFERRED EMBODIMENT

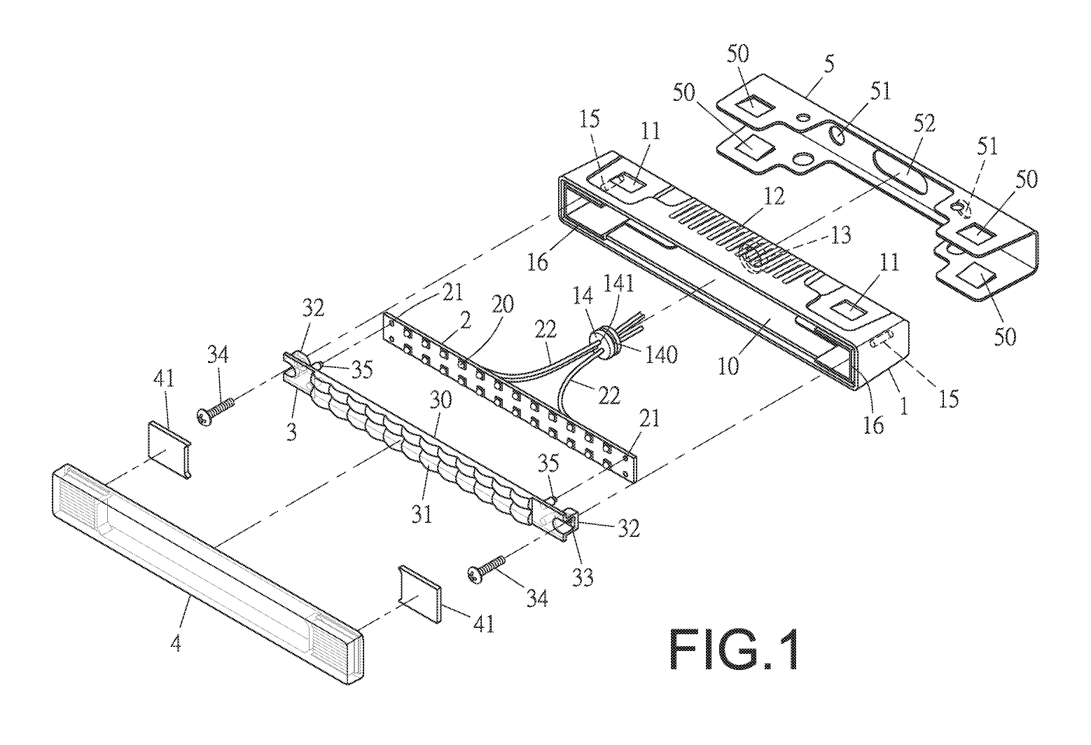

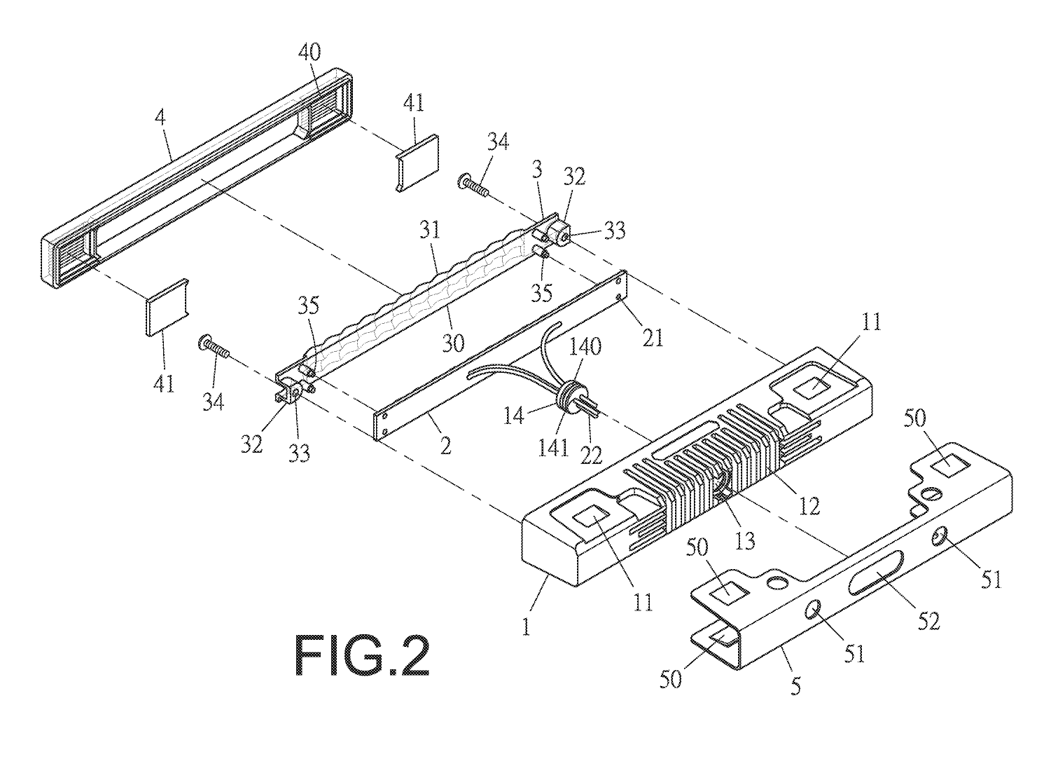

Referring to FIGS. 1 and 2, the embodiment of this present invention is consisted of a lamp base 1, a circle board 2, a lens 3, a lampshade 4 and a fixing member 5. A chamber 10 is defined inside of the lamp base 1. Plural securing grooves 11 are defined respectively on top and bottom outer wall of the lamp base 1. Several dissipation fins 12 are defined on the outer wall of the lamp base 1. A hole 13 is provided with a wire stopper 14 which has an annular groove 140 on the outer wall of the wire stopper 14 and various holes 141 at rear wall of the lamp base 1. At least two threaded holes 15 are defined inside of the chamber 10 of the lamp base 1 and a positioning groove 16 is defined along with the front edge of the lamp base 1. The circle board 2 is inserted inside of the chamber 10 of the lamp base 1. Several LED lights 20 are aligned on the circle board 2. Several positioning holes 21 bare defined respectively at the two ends of the circle board 2. Number of wires 22 provided with the circle board 2 are able to be inserted through the holes 141 of the wire stopper 14. The lens 3 is inserted inside of the chamber 10 of the lamp base 1 and located in front of the circle board 2. The rear surface of the lens 3 is plan 30 and the front surface of the lens 3 is designed in various wavy refracting faces 3. At the two ends of the lens 3 are defined respectively a convex 32 which has a thru hole 33 able to be secured by a screw 34. Various positioning projectors 35 corresponding respectively to the location of the positioning holes 21 of the circle board 2 are defined on rear surface of the lens 3. The lampshade 4 is transparency and is defined in front of the lamp base 1. A projecting edge 40 corresponding to the positioning groove 17 of the lamp base 1 is defined along with the edge at rear side of lampshade 1. Two shades 41 are provided respectively at the two ends of the lampshade 4. The fixing member 5 made of metal has plural securing members 50 corresponding respectively to the securing grooves 11 on outer wall of the lamp base 1 defined respectively on top and bottom side of the fixing member 5, various thru holes 51 and a penetrating hole 52.

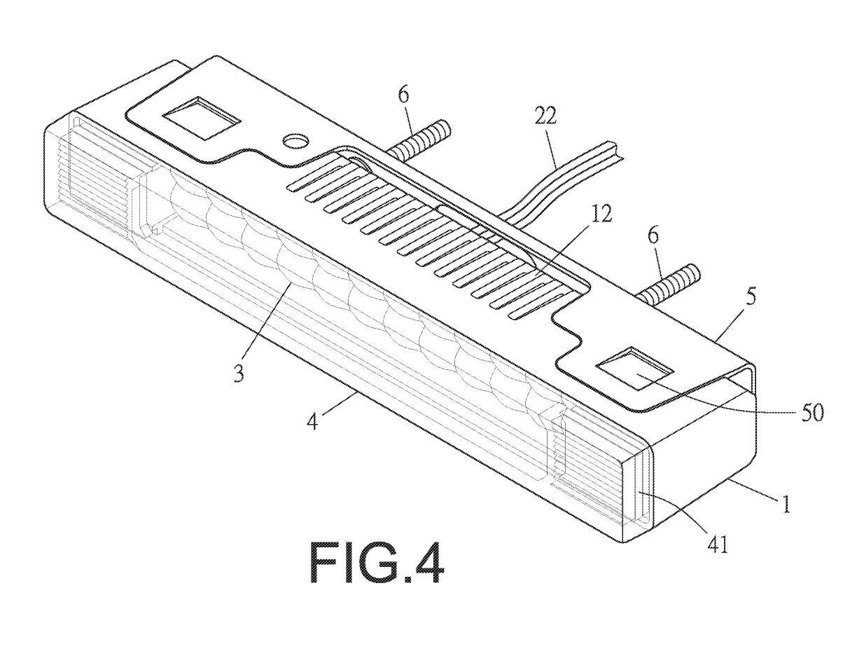

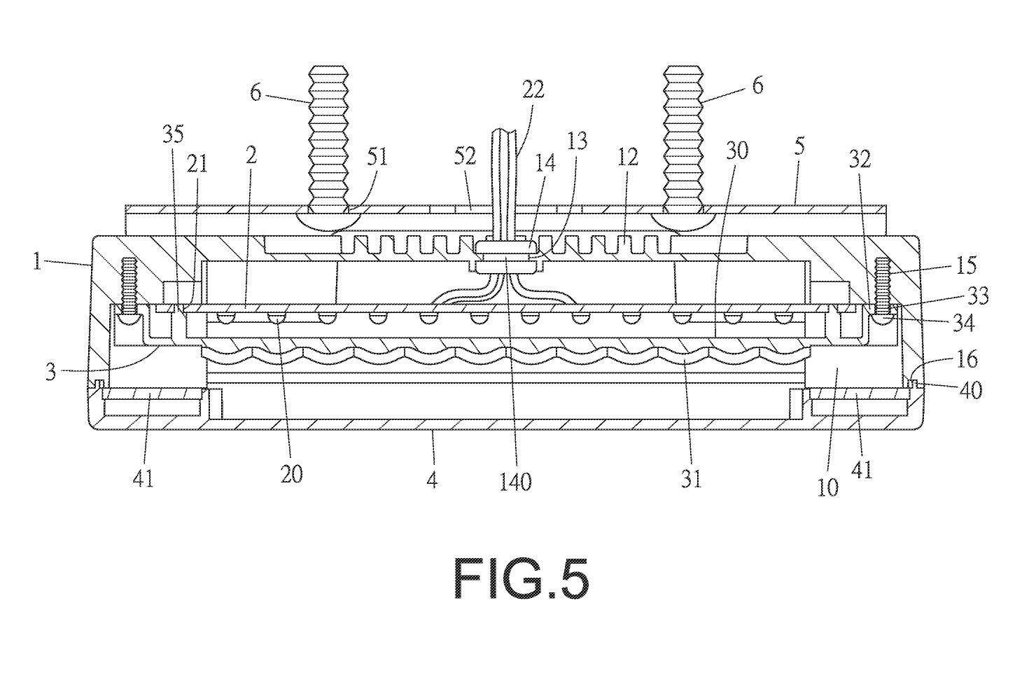

While assembling, as shown on FIGS. 1 to 5, first of all, the circle board 2 is placed behind the lens 3 so that the positioning projectors 35 of the lens 3 are able to be inserted into the positioning holes 21 of the circle board 2 so as to the circle board 2 is fixed behind the lens 3. Each location of the refracting face 31 is corresponding to the location of the LED lights 20 of the circle board 2. After the wires 22 of the circle board 2 are inserted through the holes 141 of the wire stopper 14, the wire stopper 14 is put into the hole 13 of the lamp base 1 so as to the wire stopper 14 would be engaged in the hole 13 of the lamp base 1 by the annular groove 140 in order to firmly secure the wire stopper 14 inside of the hole 13 of the lamp base 1. Then, the circle board 2 and the lens 3 are placed together inside of the chamber 10 of the lamp base 1 so that the thru holes 33 on the convex of the lens 3 are able to correspond to the threaded holes 15 inside of the chamber 10 of the lamp base 1. The screw 34 is respectively inserted through the thru holes 33 of the lens 3 and secured in the threaded holes 15 inside of the chamber 10 of the lamp base so that the circle board 2 and the lens 3 are firmly installed inside of the chamber 10 of the lamp base 1. The lampshade 4 which has the two shades 41 respectively at the two ends of the lampshade 4 is placed on the lamp base 1 by having the projecting edge 40 of the lampshade 4 inserted into the positioning groove 16 of the lamp base 1 and then sealed the lampshade 4 on the lamp base 1 by welding or glue. Finally, the assembly is completed.

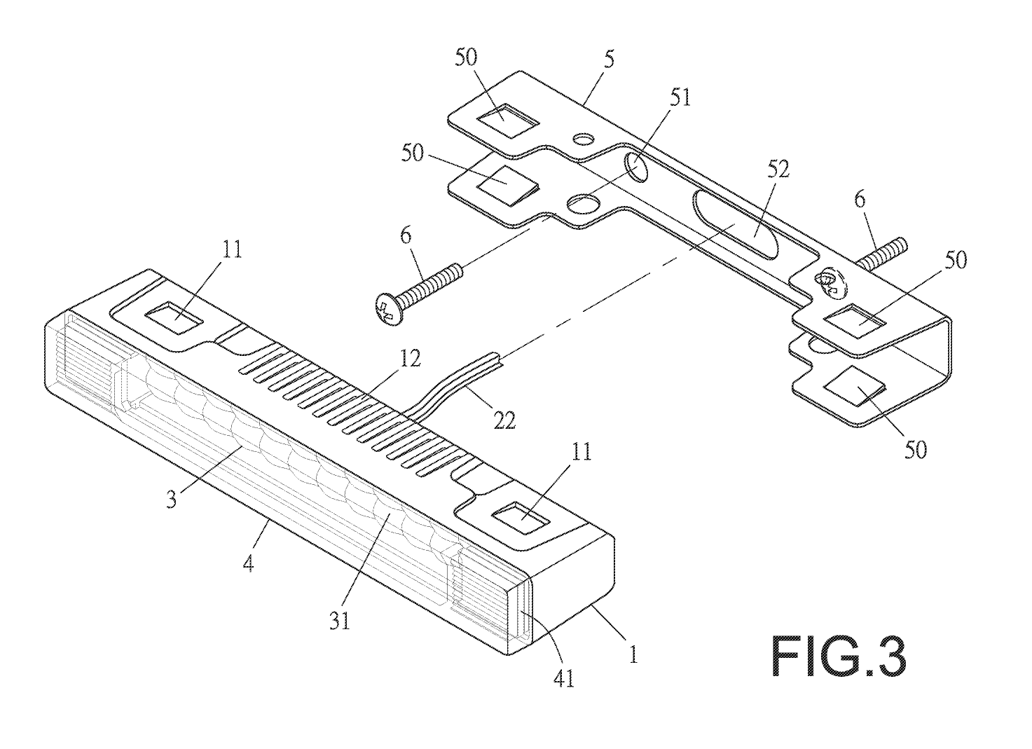

While using, as shown on FIGS. 3 to 5, the fixing member 5 is firstly secured either in front or at rear of the vehicle body by number of fasteners 6 and then the lamp base 1 after the assembly is completed is placed into the fixing member 5 so that the securing members 50 on top and bottom side of the fixing member 5 are able to be engaged into the securing grooves 11 on top and bottom outer wall of the lamp base 1 in order to firmly secure the lamp base 1 inside of the fixing member 5. The wires 22 are connected with vehicle power or direction light of a vehicle so that the installation of a daytime runner lamp into a vehicle is completed. The installation is easy and fast. The light from the LED lights 20 of the circle board 2 is evenly refracted through the refracting faces 31 of the lens 3 inside of the lamp base 1, hence, the light is well distributed without producing any glare so as to be lighted and alarmed feature. The two shades 41 respectively at the two ends of the lampshade 4 are used to shield the connection portion of the lens 3 secured inside of lamp base 1 so that the appearance would be more attractively. The daytime runner lamp would be automatically on after the vehicle engine is starting in order to be lighted and alarmed at daytime, moreover, the brightness of the daytime runner lamp would be reduced 30% at night after the headlight is on and the daytime runner lamp would be able to be flashed with the direction light. Furthermore, the daytime runner lamp could be also installed at tail of a vehicle to be a fog lamp or brake light.

While we have shown and described the embodiment in accordance with the present invention, it should be clear to those skilled in the art that further embodiments may be made without departing from the scope of the present invention.

What is claimed is:

1. A daytime runner lamp of a vehicle comprises a lamp base, a circuit board, a lens, a lampshade and a fixing member, wherein
a chamber defined inside of the lamp base; plural securing grooves defined respectively on top and bottom outer wall of the lamp base; several dissipation fins defined on the outer wall of the lamp base; a hole provided with a wire stopper at rear wall of the lamp base; at least two threaded holes defined inside of the chamber of the lamp base, and a positioning groove defined along with the front edge of the lamp base;
the circle board able to be inserted inside of the chamber of the lamp base; several LED lights aligned on the circle board; at least one positioning hole defined respectively at the two ends of the circle board; number of wires provided with the circle board able to be inserted through the wire stopper.
the lens able to be inserted inside of the chamber of the lamp base and located in front of the circle board; the rear surface of the lens designed in plan and the front surface of the lens designed in various wavy refracting faces respectively corresponding to the LED lights on circle board; at the two ends of the lens are defined respectively a convex with a thru hole able to be inserted by a screw used to be secured into the threaded hole of the lamp base; at least two positioning projectors corresponding respectively to the positioning holes of the circle board are defined on rear surface of the lens;
the lampshade which is transparency and placed in front of the lamp base having projecting edge corresponding to the positioning groove of the lamp base defined along with the edge at rear side of lampshade; and
the fixing member placed behind the lamp base having plural securing members corresponding respectively to the securing grooves on outer wall of the lamp base defined respectively on top and bottom side of the fixing member, various thru holes and a penetrating hole.

2. The daytime runner lamp of a vehicle as claimed in claim 1, wherein the wire stopper has an annular groove able to be engaged into the hole of the lamp base on the outer wall and at least one hole able to collect the wires of the circle board.

3. The daytime runner lamp of a vehicle as claimed in claim 1, wherein two shades are defined respectively at the two ends of the lampshade.
